(19) United States
(12) Patent Application Publication
(10) Pub. No.: US 2016/0031544 A1
(43) Pub. Date: Feb. 4, 2016

(54) GLASS PANEL FOR A SPACE AIRCRAFT

(71) Applicant: AIRBUS DEFENCE AND SPACE SAS, Les Mureaux (FR)

(72) Inventor: Yohann CORABOEUF, Merignac (FR)

(21) Appl. No.: 14/781,937

(22) PCT Filed: Apr. 4, 2014
(86) PCT No.: PCT/EP2014/056860

§ 371 Date: Oct. 2, 2015

(30) Foreign Application Priority Data
Apr. 4, 2013 (FR) 1353031

(51) Int. Cl. B64C 1/14; B64D 15/00; B64G 1/22

(52) U.S. Cl. CPC B64C 1/1492; B64G 1/22; B64D 15/00

(57) ABSTRACT

The invention relates to a glass panel for an aircraft suitable for a suborbital flight and an aeronautical flight, including an outer panel made of polycarbonate or aluminosilicate for temperature resistance, a main panel for pressure resistance, sized according to standard aeroplane safety factors, and an inner panel, providing redundancy for the main panel, sized with a minimum pressure margin, the outer, main and internal redundancy panels being separated from one another by spaces. The invention also relates to an aircraft including windscreen elements and portholes made using the glass panel.

### CROSS REFERENCE TO RELATED APPLICATIONS

This application is the National Stage of International Application No. PCT/EP2014/056860, having an International Filing Date of 4 Apr. 2014, which designated the United States of America, and which International application was published under PCT Article 21(s) as WO Publication No. 2014/161999 A1, and which claims priority from, and the benefit of French Application No. 1353031, filed 4 Apr. 2013, the disclosures of which are incorporated herein by reference in their entireties.

### BACKGROUND

1. Field

The presently disclosed embodiment, relates to glazing for space aircraft and especially glazing for spaceplane type space aircraft comprising a windshield and passenger windows.

The term spaceplane refers to a vehicle capable of moving in the Earth's atmosphere like an airplane, but also capable of suborbital space flight, for example using a rocket engine enabling it to reach an altitude of at least 100 km. Generally speaking, the maximum speed of such a spaceplane does not exceed Mach 5 throughout its flight envelope.

2. Brief Description of Related Developments

By definition, glazing for aircraft is intended to allow passengers or flight crew to see outside the aircraft.

For this reason, these glazing panels must not only allow one to see out, but they must also withstand the same environmental and operational stresses as the other parts of the aircraft, and thus resist the forward movement of the aircraft through the air, ensure that the pressure inside the aircraft is maintained, resist various external aggressions during flight such as rain, hail, bird strikes or, while on the ground, such as gravel, withstand and filter radiation, and they must be able to be de-iced, and ensure passenger safety in the event of a malfunction, etc.

There are large amounts of data available and extensive experience with regard to glazing for civil and military aircraft. Usually, two types of glazing are distinguished for aircraft:
glazing for windshields and cockpit,
glazing for passengers (windows).

The first type of glazing is subject to the greatest aggressions due to its position at the front of the aircraft.

The production of windshields consisting of several layers is known, for example, from documents US2010/0020381 A1, US2010/0163676 A1, EP 0 322 776 A2.

The glazing of aeronautic windshields generally has a multilayer structure that alternates layers of glass, acrylic or polycarbonate with vinyl layers.

They are assembled by a peripheral device.

A known example of a windshield panel for airliners, such as the Airbus A300, A320 and A340 aircraft, features 3 layers of safety glass, vinyl interlayer films to separate the glass layers, urethane interlayers to bond the vinyl interlayers to the glass layers and defrosting and anti-fogging means.

Most of the known windshield glazing assemblies are thus based on a multi-ply structure consisting of solid interlayers between the layers of safety glass and acrylic material.

The drawback of these multi-ply structures is that they do not have a heat conduction rupture zone which could be accomplished by an air gap or vacuum. Overall, these structures consist of heat conducting walls.

For passenger windows, it is known to produce glazing resistant to the cabin pressure by assembling two panes of glass or acrylic material which are maintained separated by a peripheral seal to form an air gap and to add a third pane of acrylic or other transparent plastic on the inside so as to form a thermal shield and to prevent the passenger from touching the window.

In such an arrangement, a small hole in the inner glass pane connects the air gap with the inside of the aircraft such that only the outer glass or acrylic pane is subjected to pressure differentials, the inner glass pane providing fail-safe protection in the event the outer pane should rupture.

Owing to the presence of an air gap between two panes of glass or equivalent material, these structures offer better thermal insulation than multi-ply structures.

Spacecraft encounter different environmental conditions than airplanes; in particular, spacecraft designed to return to Earth are exposed to extremely high temperatures that even supersonic aircraft do not encounter.

Furthermore, in space, radiation is more intense, over the entire range of the electromagnetic spectrum. Moreover, the outside temperature can be very cold or very hot. More precisely, the walls can be very hot (+150° C.) or very cold (−150° C.), depending on whether or not they are exposed to sunlight.

For this reason, the design of this glazing must include a highly refractory outer wall, and the glazing assembly must be a good thermal insulator.

Furthermore, an aircraft can encounter micrometeorites during space flight.

For the space capsules of the Apollo program, the windows were comprised of a thick outer pane made of silica and two inner panes made of alumina/silicate.

The outer pane was intended to withstand impacts and heat during the return to Earth, and the inner panes were intended to resist pressure, the space between the outer pane and the inner pane being placed in a vacuum during the orbital phase while the space between the inner panes was filled with pressurized dry nitrogen.

The NASA space shuttle also included three panes. The front glazing was fitted with an outer thermal resistance pane of approximately 16 mm thick, secured to the fuselage structure of the shuttle, an intermediate fail-safe pane of approximately 33 mm thick in the event of rupture of the outer pane, and an internal pressure resistance pane of the order of 16 mm thick. The intermediate pane and the inner pane are assembled together with a seal, not on the shuttle fuselage, but on the sealed compartment intended for the flight crew.

The central pane and the outer pane are made of fused silica glass.

The choice of materials for space aircraft is crucial, as is the choice of materials for the entire structure of an aircraft. Technical efficiency must be sought with the lowest possible weight.

It is therefore essential that materials are chosen based on the specific needs of the vehicle that one wants to build.

Thus, the outer pane of glazing for a spacecraft intended to return to Earth from a terrestrial orbit or beyond must be made of fused silica, highly refractory but with a density of 2.6, the density being 2.5 for glass in general, while a more impact-resistant polycarbonate has a density of 1.1.

It should be noted that no certification standards or norms are defined for spacecraft while atmospheric aircraft are likely to comply with strict certification standards and norms that will greatly influence the dimensioning of their elements.

The question arises for a spaceplane travelling to the intermediate altitudes in the area between the atmosphere and orbital space and which will encounter extreme temperatures upon re-entry.

### SUMMARY

The presently disclosed embodiment thus aims to define an optimized glazing system for an aircraft of spaceplane type, which successively operates as a conventional subsonic aircraft, and is therefore subject to all the requirements of a conventional civil aircraft, particularly with regard to its certification, and as a spacecraft, and is thus subject to vacuum and to atmospheric re-entry with new requirements that are currently not established.

The requirements identified for the design of windshields/windows for aircraft such as spaceplanes performing suborbital flights are:
protection against kinetic heating during atmospheric re-entry, although with lesser kinetic heating during suborbital flight in relation to orbital vehicles,
protection against micro-impacts during ballistic phases, on both the windshield and windows, and aeronautical type impact for windscreens during aeronautical flight phases. A spaceplane is more exposed than a capsule carried by a rocket as it performs longer atmospheric flights for a longer time and horizontally, and due to the fact that it takes off and lands on the ground.

Furthermore, the glazing of the disclosed embodiment must also be heat insulating. It must also absorb sunlight and X-rays and resist high-velocity micro space debris. It must protect passengers from solar radiation during the extra-atmospheric flight phase (spatial requirement).

This glazing must of course maintain the pressure differential between the cabin and the atmospheric environment during both aeronautical flight and space flight, safeguard the vehicle in case of accidental rupture of the panel supporting cabin pressure and provide fail-safe protection of the pressure panel in order to comply with civil aviation certification requirements.

Protection for the windows against internal aggressions by the passengers must be provided while ensuring a clear view outside the vehicle during all phases of flight for the pilot, aeronautic requirement, and passengers; in the context of a space flight with passengers, the windshield and the side windows must be equipped with defrosting devices on all layers of the glazing.

Finally, the design of the system must be optimized in terms of weight, as with any aerial vehicle; although this requirement is even more important in the context of a spaceplane.

Finally, the glazing must meet at least the certifications as glazing for atmospheric aircraft transporting persons.

To this end, the presently disclosed embodiment proposes glazing for aircraft adapted to suborbital flight and aeronautic flight, which comprises an outer temperature resistant panel, made of polycarbonate or aluminosilicate for example, a main pressurization pressure resistant panel, and an inner panel providing fail-safe protection for the main panel, for which the outer, main and inner fail-safe panels are separated from each other by spaces filled with gas or empty, for which the main and inner panels are designed according to civil aviation certification standards.

According to a first aspect of the main panel and the fail-safe panel, the space between the main panel and the inner fail-safe panel contains dry air or nitrogen to prevent condensation due to ambient cold temperature.

According to a second aspect of the main panel and fail-safe panel, the space between the main panel and the inner fail-safe panel is placed in a vacuum.

According to a first aspect of the main and outer panels, the space between the outer panel and the main panel is filled with a separating layer of air.

According to a second aspect of the main and outer panels, the space between the outer panel and the main panel is placed in a vacuum.

According to a third aspect of the main and outer panels, the outer panel comprises at least one pressure balancing hole between its outer surface and its inner surface.

This particularly advantageous aspect completely eliminates the pressure stresses on the outer panel which therefore must only fulfill its impact protection and thermal barrier functions.

Advantageously the main panel is made of stretched acrylic material, according to American standard MIL PRF-25690B of Jan. 29, 1993.

In the case where the glazing forms a passenger window, an additional thin passenger protection panel is added to protect the functional panels of the glazing.

The glazing of the disclosed embodiment advantageously comprises one or more films on the main panel to provide protection from solar radiation.

It advantageously includes at least one defrosting type heating film on the inner surface of the outer panel and preferably at least one defrosting type heating film (10) on the outer surface of the main panel.

It advantageously comprises an anti-fogging type heating film on the interior panel.

The main panel preferably has a safety factor of at least 4 in terms of pressure resistance. In a particular aspect, the main panel has a safety factor of at least 8 in terms of pressure resistance.

The inner panel preferably has a safety factor of at least 2 in terms of pressure resistance. In a particular aspect, the inner panel has a safety factor of at least 3 in terms of pressure resistance.

The disclosed embodiment applies to a suborbital aircraft, i.e. reaching altitudes above 100 km and re-entry speeds of Mach 3 to 5, comprising windshield and/or window elements made with glazing according to at least one of the characteristics defined above.

### BRIEF DESCRIPTION OF THE DRAWINGS

Other features and advantages of the disclosed embodiment will become apparent on reading the description of non-limiting examples of the aspects of the disclosed embodiment which follows, made in reference to the annexed drawings which show:

FIG. 1, shows glazing of the disclosed embodiment mounted in a clamping assembly; and

FIG. 2, shows glazing of the disclosed embodiment mounted in a two-part assembly.

### DETAILED DESCRIPTION

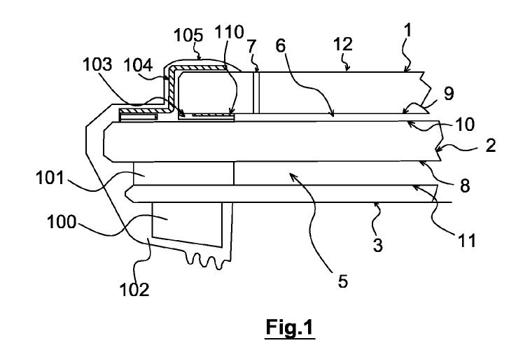

The disclosed embodiment is described in FIG. 1 within the scope of glazing assembled in a known type of framework adapted to be secured by clamping, the framework comprising shims 100, 101, 103, with the shims 101, 103 defining spaces 5, 6 between the glazing panels, an anti-moisture seal 105, and a Z-shaped retaining plate 104.

According to the disclosed embodiment, the glazing comprises an outer panel 1, also referred to as the outer pane, which must primarily be able to withstand the stresses of impact and thermal insulation resistance during atmospheric re-entry.

Impacts refer to the impacts that occur in the aeronautic field and especially bird strikes, but also the impacts that may be caused by objects such as space debris in the suborbital flight phase.

Unlike an atmospheric airplane, the passenger windows must be designed with a high degree of resistance, or even the same resistance as the windshield glazing owing to the high-velocity space debris that may impact the aircraft at any angle.

For the outer panel, common to the glazing of windshields and windows, which provides protection against thermal overheating during atmospheric re-entry and against impacts, the preferred material is a Lexan type polycarbonate that has good impact and temperature resistance. Its inner and outer surfaces must be protected from both the internal and external environment and the outer panel shall be covered with protective layers or surface treatments known in the art of the manufacture of polycarbonate panels, such as anti-UV surface treatment for example.

This outer panel, which is not doubled, is insulated from the other panels by a layer of air or separating gap, this layer being connected to the outside of the aircraft by one or more small pressure balancing holes 7.

On the inside, the glazing of the disclosed embodiment comprises a first inner panel, referred to as the main panel 2.

According to the disclosed embodiment, there is a space between the outer panel 1 and the main panel 2. This space is created by means of a peripheral seal 101 in the case of FIG. 1 or a stack of frame elements 106 and seals 101, 109.

This is contrary to the technique of glazing such as that used for atmospheric airplanes where the space between the panes is filled with a material such as a vinyl layer.

According to the disclosed embodiment, pressure resistance is ensured by the second panel or main panel 2. The thickness and the material of this main panel comply with the aviation industry's standard safety factors regarding pressure resistance and the panel is preferably made of acrylic material. Advantageously, the main panel is made of stretched acrylic material, shaped or in plate format depending on the case, of type 2 with improved moisture resistance according to US standard MIL-PRF-25690B of Jan. 29, 1993. This material allows the safety factor for the panel's pressure resistance to be divided in half, in relation to a cast acrylic.

In case of an accident involving the main panel, the resistance of the glazing is ensured by adding a second inner panel 3 dimensioned with a lower design margin in relation to the pressure to be supported.

The in-flight thermal insulation, outside atmospheric re-entry, is ensured by an air gap between the two pressure resistance panels.

In order for the inner panel to ensure its fail-safe function, this space must be sealed with a gas at a pressure equivalent to that inside the vehicle (0.8 bar). However, a maintenance device for maintaining this pressure on all flights must be provided; this is different from spatial solutions, where there are only a few flights separated by long periods.

The main panel and fail-safe panel adapted to support the internal cabin pressure are made of acrylic material. The use of panels made of acrylic material is optimum in terms of weight and the material also allows at least part of the X-rays to be filtered while ensuring good clarity.

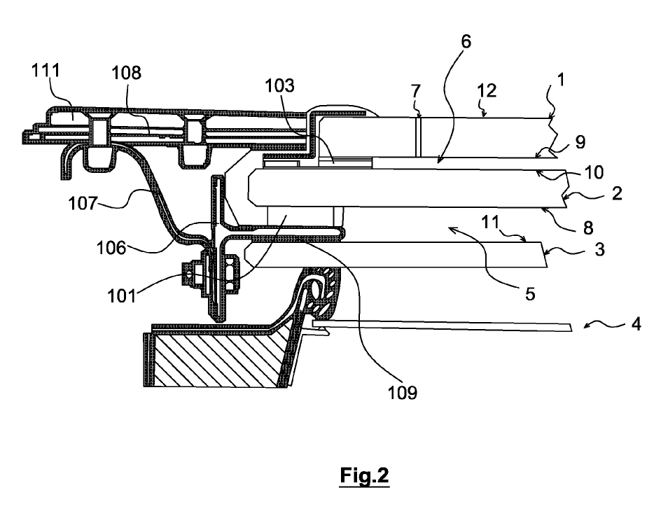

In the case of the windows, protection against internal attacks by passengers is ensured by adding a very thin panel 4 to protect the window as shown in FIG. 2.

According to this FIG. 2, the panes are secured differently from those in FIG. 1 since the second inner panel is mounted separately while the outer and main panels are mounted between a frame 106 secured to the fuselage 108 by a clamping device 107 while a frame 111 surrounding the window reinforces said fuselage 108 around the hole receiving the window.

Protection from solar radiation is completed by adding a protective solar film 8 that is, according to the example, applied to the inner surface of the main panel 2.

Furthermore, frost protection is ensured by defrosting heating films 9, 10 on the inner surface of the outer panel and on the outer surface of the main panel. These films are electrically connected by conductive tracks such as track 110 shown in FIG. 1.

The glazing further comprises a film or anti-fog coating 11, for example a heating film, on the inner panel.

These coatings are, for example, thin meshes connected to an electric power source or a coating such as that known under the brand NESATRON by PPG Industries Inc.

The inner panel 3 also improves thermal insulation by means of a sufficient layer of air in the gap 5 between the inner panel and the pressure load-bearing main panel 2.

The windshield or windows according to the disclosed embodiment are fastened to the aircraft structure according to known aeronautical technologies which allow the glazing to be rapidly removed.

In brief, the disclosed embodiment concerns glazing in compliance with aircraft certifications and therefore complying with the recommendations of the applicable standards and therefore the standard CS23: “Certification Specifications for Normal, Utility, Aerobatic, and Commuter Category Aeroplanes CS-23 Amendment 3 20 Jul. 2012” of the European Aviation Safety Agency on civil aircraft, of the recommendation introducing safety factors applicable to such glazing; the “Advisory circular” recommendation AC No. 25.755-1 of Jan. 17, 2003 of the FAA of the US Department of Transportation that defines a first factor of 2 for the degree of increased loading above ultimate in §8a3, and a second safety factor of 4 for an acrylic or a polycarbonate and a safety factor of 2 for a stretched acrylic in 8c5, i.e. a fail-safe safety factor for the pressure resistance of 8 for an acrylic or a polycarbonate, 4 for a stretched acrylic.

In the absence of certification for spaceplanes, the choice is to dimension the main panel according to the above civil aviation standards.

The fail-safe panel, however, is dimensioned to the minimum level, i.e. only in relation to the ultimate loading.

For the acrylic material, standard MIL-PRF 25690B of Jan. 29, 1993 is used as the material specification, for type 2 stretched acrylic, shaped or in plate format depending on the application.

It is thus possible to obtain the aircraft certification and, for the suborbital or orbital flight part, the presently disclosed embodiment plans to add a specific outer panel adapted to withstand heat and impacts.

For a concrete example, let us take the case of an aircraft defined according to the applicable certification standards and which has windows of 340×240 mm with two panels for which the outer panel is under the entire pressure. The nominal pressure difference between the cabin and the outside is 0.582 mbar (pressurization at 8,000 feet for a maximum altitude of 42,000 feet).

When the outer panel is made of polymethyl-methacrylate, in order to take into account the “Advisory circular” recommendation AC No. 25.755-1 of Jan. 17, 2003 of the FAA of the US Department of Transportation, and thus have a safety factor of at least 8, the calculations show that the inner panel must have a thickness of 10.16 mm, with its deflection being 1.2 mm.

In case of failure of the outer panel, the inner panel is designed to contain only the ultimate cabin pressure. It has a thickness of 6.35 mm, with a safety factor greater than 2, of the order of 3 to limit the maximum deflection to 4 mm.

The glazing of the passenger cabin—the windows—of the spaceplane of the presently disclosed embodiment are designed as a compromise between the constraints of a conventional civilian jet-powered transport aircraft and the environmental constraints, as well as the load borne by a sub-orbital vehicle.

In accordance with the aircraft certification process, the main panel, adapted to withstand the cabin pressure, is dimensioned by finite element computation with a safety factor of at least 8 and a maximum deflection at its center of 1.2 mm.

For a panel having a surface area of 0.09 m² subjected to conventional cabin pressure of 0.750 mbar, the thickness of the main panel made of stretched acrylic material is 12.3 mm and its overall weight is of the order of 1.6 kg.

The inner panel is designed to withstand the cabin pressure should the main panel fail, and is provided with a safety factor of 3 in order to be consistent with civilian aircraft.

With the same material as the main panel, a thickness of 7 mm provides a safety factor of 3, for a weight of 1 kg.

The outer panel is adapted to protect the aircraft from the heat of atmospheric re-entry and damage from foreign objects in the space (micrometeorites) or aeronautical field.

According to one aspect of the disclosed embodiment, the outer panel is dimensioned identically for both the windows and the windshield and is produced taking the bird strike criteria into account as defined in standard CS-23: “Certification Specifications for Normal, Utility, Aerobatic, and Commuter Category Aeroplanes CS-23 Amendment 3 20 Jul. 2012” paragraph 23.775 (h) (1) of the European Aviation Safety Agency relative to civil aircraft.

As such, the outer panel of the glazing of the present aircraft is compliant with the outer panel of a civil aircraft windshield.

The material selected is a polycarbonate (Lexan™ type), with a density of 1,160 kg/m³, for a suborbital spaceplane not exceeding Mach 5 in its flight envelope.

This outer panel is thus designed to withstand a bird strike, such that its maximum deflection during the impact does not result in contact between the outer panel and the main panel. For a gap between the two panels of 5 mm, a Lexan panel having a thickness of 12 mm, i.e. 1.5 kg, is suitable.

The cockpit windows—the windshield—are designed using the same process, but the required thicknesses obviously depend on the surface area of each window: for each window geometry, and for each panel, finite element calculation must be used to ensure that the defined dimensioning criteria are respected.

This generally results in greater thicknesses, because the windshield windows are larger in size than the passenger cabin windows. These dimensions must be optimized so as not to significantly increase the weight of the windshield panels.

The disclosed embodiment is not limited to the examples shown, and particularly the panel 4 may be assembled with the panels 1 to 3 to produce the windows.

Furthermore, the disclosed embodiment applies to spaceplanes capable of reaching higher speeds. In such cases, materials adapted to the highest temperatures encountered, of aluminosilicate type, or fused silica are used for the outside panel, the main and inner panels remaining in compliance with the definitions of the aircraft standards.

What is claimed is:

1. An aircraft glazing adapted to a suborbital flight and an aeronautical flight, comprising an outer panel for temperature resistance, a main panel for pressurization pressure resistance and an inner panel, providing fail-safe protection for the main panel, for which the outer, main and inner fail-safe panels are separated from each other by gaps filled with gas or empty, for which the main and inner panels are dimensioned as claimed in civil aviation certification standards.

2. The glazing as claimed in claim 1 wherein the gap between the main panel and the inner fail-safe panel contains dry air, or nitrogen.

3. The glazing as claimed in claim 1 wherein the gap between the main panel and the inner fail-safe panel is placed in a vacuum.

4. The glazing as claimed in claim 1 wherein the gap between the outer panel and the main panel is filled with a layer of separation air.

5. The glazing as claimed in claim 1 wherein the gap between the outer panel and the main panel is placed in a vacuum.

6. The glazing as claimed in claim 1 wherein the outer panel comprises at least one pressure balancing hole between its outer surface and its inner surface.

7. The glazing as claimed in claim 1 wherein the main panel is made of stretched acrylic material, as claimed in American standard MIL PRF-25690B of Jan. 29, 1993.

8. The glazing as claimed in claim 1 forming a passenger window and comprising a thin additional panel for passenger protection.

9. The glazing as claimed in claim 1 comprising one or more films to offer protection from solar radiation on the main panel.

10. The glazing as claimed in claim 1 comprising at least a de-icing heating coating on an inner surface of the outer panel.

11. The glazing as claimed in claim 1 comprising at least a de-icing heating coating on an outer surface of the main panel.

12. The glazing as claimed in claim 1 comprising an anti-fog heating film on the inner panel.

13. The glazing as claimed in claim 1 wherein the main panel has a safety factor of at least 4 for pressure resistance.

14. The glazing as claimed in claim 1 wherein the main panel has a safety factor of at least 8 for pressure resistance.

15. The glazing as claimed in claim 1 wherein the inner panel has a safety factor of at least 2 for pressure resistance.

16. The glazing as claimed in claim 1 wherein the inner panel has a safety factor of at least 3 for pressure resistance.

17. The glazing as claimed in claim 1 wherein the outer panel is made of polycarbonate or aluminosilicate.

18. A suborbital aircraft comprising windshield and/or window elements made of glazing as claimed in claim 1.
